(19) United States
(12) Patent Application Publication
(10) Pub. No.: US 2007/0080586 A1
(43) Pub. Date: Apr. 12, 2007

(54) Emergency Battery Back-Up Power for Traffic Control Signals

(76) Inventor: Steven C. Busick, Pembroke Pines, FL (US)

Correspondence Address: STEVEN C. BUSICK, 1161 N.W. 87 WAY, PEMBROKE PINES, FL, 33024, US

(21) Appl. No.: 11/163,242

(22) Filed: Oct. 11, 2005

(51) Int. Cl. H02J 9/00

(52) U.S. Cl. 307/64

(57) ABSTRACT

An self contained Emergency Battery Back-UP Power Station for traffic signal controllers having a general utility power supply, the Emergency Battery Back-UP Power Station having a small footprint cabinet containing at least two batteries, at least one DC to AC inverter, a battery charger, a manual transfer switch selectively connecting the utility power supply or the Back-UP Emergency Power Station to the traffic signal controller, electrical disconnecting means, a receptacle to connect a portable generator to recharge batteries if needed, combined in a tamper-proof weather-proof enclosure.

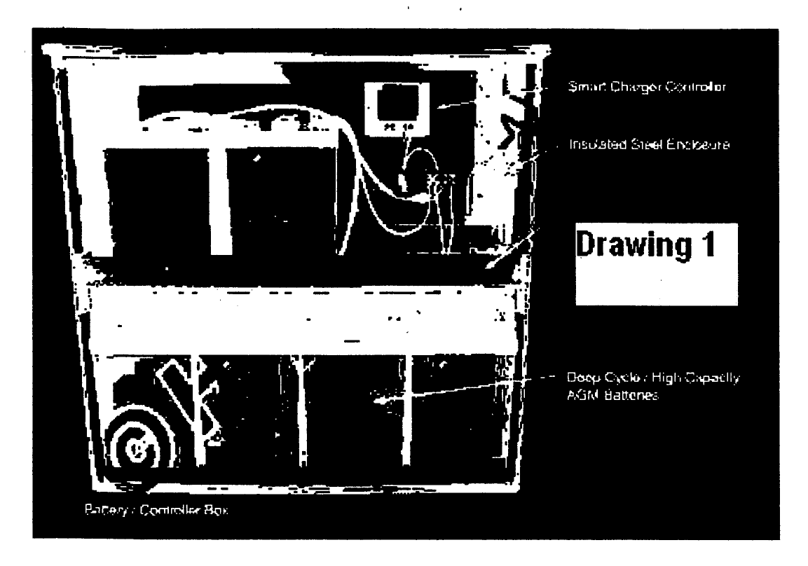

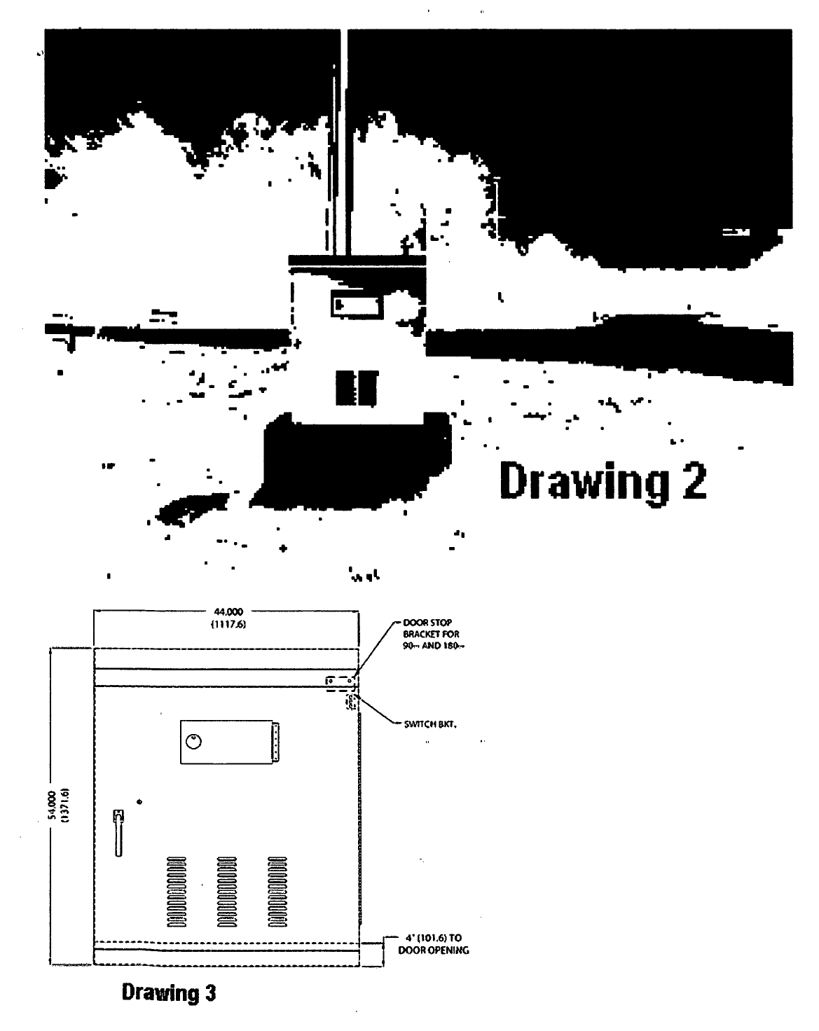

### BACKGROUND OF THE INVENTION

This invention relates to a self-contained Emergency Battery Back-UP Power Station and in particular to a stand-by electrical power installation that is manually activated during a power outage. In the state of Florida where violent storms are a common place, the unplanned loss of power particularly when in reference to traffic lights, can have serious consequences. In such an environment, the Emergency Battery Back-UP Power Station is unattended and subject to the elements. Therefore, a Emergency Battery Back-UP Power Station of this type must comprise a stand-alone unit that has a protective housing and occupies minimal space, particularly in the intended preferred use as an auxiliary power supply for traffic control signals.

### SUMMARY OF THE INVENTION

The Emergency Battery Back-UP Power Station of this invention is a self-contained auxiliary power supply for an outdoor installation where a supply of emergency power is required for traffic intersection controller backup. The Emergency Battery Back-UP Power Station of this invention includes at least two batteries, at least one DC to AC inverter, a battery charger, a manual transfer switch, electrical disconnecting means, a receptacle or other means to hook a portable generator to recharge batteries if needed, combined in an enclosure. The Emergency Battery Back-UP Power Station invention is self-contained in a tamper-proof weather-proof enclosure.

What is claimed is:

1. An self contained Emergency Battery Back-UP Power Station for supplying emergency power to a system powered by conventional utility power, at least two batteries, at least one DC to AC inverter, a battery charger, a manual transfer switch, disconnecting means, a receptacle or other means to hook a portable generator to recharge batteries if needed, combined in a tamper-proof weather-proof enclosure.

2. A receptacle to connect a portable generator to recharge the batteries of the Emergency Battery Back-UP Power Station of claim 1.

3. The receptacle of claim 2 is attached to the batteries charging circuitry and securely installed on one of the sides of the enclosure, making the receptacle readily accessible from the outside without opening the enclosure.

4. A bank of batteries of claim 1 will be connected in parallel increasing the length of time a load may be connected to the power station.

5. A manual transfer switch of claim 1 is connected to the utility power supply, the batteries by way of the inverter, and to the lighting controller. This allows the load of the controller to be manually switched between the utility power and the power supplied from the batteries.
